(19) United States
(12) Patent Application Publication
(10) Pub. No.: US 2025/0319406 A1
(43) Pub. Date: Oct. 16, 2025

(54) SYSTEM AND METHODS FOR ELECTRONIC GAMING CONTROL AND PERFORMANCE NORMALIZATION USING ARTIFICIAL INTELLIGENCE

(71) Applicant: Sony Interactive Entertainment LLC, San Mateo, CA (US)

(72) Inventors: Charles McCoy, San Diego, CA (US); True Xiong, San Diego, CA (US)

(73) Assignee: Sony Interactive Entertainment LLC, San Mateo, CA (US)

(21) Appl. No.: 18/633,853

(22) Filed: Apr. 12, 2024

(51) Int. Cl. A63F 13/67

(52) U.S. Cl. CPC A63F 13/67

(57) ABSTRACT

Systems, processes and device configurations are provided for electronic gaming control and performance normalization for electronic games, such as multiplayer, network or cloud based games, and for virtual reality and augmented reality applications. Processes include receiving a game data stream for an electronic game, analyzing performance using the game data stream, determining a user performance rating based on gameplay actions and determining a normalization setting modifying at least one game operation of the electronic game. Processes and device configurations can analyze user gameplay experience using game stream data to determine parameters of the user experience affected by one or more of network latency, device capability differences, and user abilities. User gameplay experience may be characterized and one or more normalization settings for modifying game operations may be determined. By normalizing game operations, players of different abilities or with different device capabilities may be provided a normalized game session.

### FIELD

The present disclosure is directed to interactive entertainment and electronic video gaming, including system and network operations, gaming device operations, processes, configurations, user interface control and control device configurations.

### BACKGROUND

Gaming systems come in many different configurations, including games on computer systems and console games. These different systems may offer players different types of gaming experiences even when hosting similar game titles. Similarly, electronic games over network communications, such as multiplayer games, may allow users to interact and play electronic games with one or more other users over the network using similar or different gaming configurations. Game titles popular for network gaming include fighting games, first person shooters, third-person shooters, multiplayer online battle, racing, and strategy games. Network electronic games are popular for personal use and for game competitions including Esports (electronic sports, competition using video games). There may be many factors that lead to different gameplay experiences, including factors beyond differences in in system configuration. There is a desire to improve player experience despite differences in game systems. There is also a desire to limit or remove differences of game systems and configurations for game play. However, it may be difficult for conventional devices and configurations to detect differences in user experience. In addition, existing devices are not configured to detect differences in gameplay experience. There is a need and a desire to provide users of electronic games features for adjusting game play experiences.

### BRIEF SUMMARY OF THE EMBODIMENTS

Disclosed and described herein are systems, methods and configurations for electronic gaming control and performance normalization. In one embodiment, a method includes receiving, by a device, a game data stream for an electronic game, wherein the game data stream includes game data for at least one user of the electronic game, analyzing, by the device, performance of the at least one user using the game data stream, and determining, by the device, a user performance rating for the at least one user, wherein the user performance rating is determined based on gameplay actions of the least one user. The method also includes determining, by the device, a normalization setting for the at least one user of the electronic game based on the user performance rating, the normalization setting modifying at least one game operation of the electronic game, and controlling, by the device, output of the game data stream using the normalization setting for the at least one user.

In one embodiment, receiving the game data stream includes receiving the game data stream for the at least one user, receiving a game data stream for at least one second user, and where the normalization setting is determined based on performance rating of the at least one user relative to a performance rating of the at least one second user.

In one embodiment, analyzing performance of the at least one user includes tracking user game stream data for the electronic game for a period of time and detecting at least one of user performance data for the game, network lag data and device lag data.

In one embodiment, determining a performance rating for the at least one user includes using a machine model to determine at least one normalization parameter for modification of a game function, the machine model trained to identify at least one of user performance for the game, network lag and device lag for normalization.

In one embodiment, determining a performance rating for the at least one user includes determining at least one reaction time measurement for the at least one user relative to electronic game.

In one embodiment, determination of a normalization setting for the at least one user includes identifying at least one game feature for modification, and wherein the normalization setting is determined based a performance rating and at least one normalization parameter for the user.

In one embodiment, the normalization setting for the at least one user includes modification of at least one game feature to reduce the constraints for completing the game function by the user.

In one embodiment, the normalization setting for the at least one user includes modification of at least one game feature to reduce network lag for the at least one user.

In one embodiment, the normalization setting for the at least one user includes modification of at least one game feature to reduce hardware lag of the at least one user.

In one embodiment, the method includes updating a machine model for normalization based on the analysis of user performance for controlled output with at least one normalization setting.

Another embodiment is directed to a device configured for electronic gaming control and performance normalization. The device includes an interface, memory storing executable instructions, and a controller coupled to the interface and memory. The controller is configured to receive a game data stream for an electronic game, wherein the game data stream includes game data for at least one user of the electronic game, and analyze performance of the at least one user using the game data stream. The controller is configured to determine a user performance rating for the at least one user, wherein the user performance rating is determined based on gameplay actions of the least one user, and determine a normalization setting for the at least one user of the electronic game based on the user performance rating, the normalization setting modifying at least one game operation of the electronic game. The controller is configured to control output of the game data stream using the normalization setting for the at least one user.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 is a graphical representation of electronic gaming control and performance normalization according to one or more embodiments;

FIG. 2 illustrates a process for electronic gaming control and performance normalization according to one or more embodiments;

FIG. 3 illustrates a graphical representation of a device configuration according to one or more embodiments;

FIG. 4 illustrates a graphical representation of normalization according to one or more embodiments;

FIG. 5 illustrates a graphical representation of user performance training according to one or more embodiments; and

FIG. 6 illustrates a graphical representation of performance normalization according to one or more embodiments.

### DETAILED DESCRIPTION OF THE EXEMPLARY EMBODIMENTS

### Overview and Terminology

One aspect of the disclosure is directed to electronic gaming control and performance normalization. As referred to herein, performance normalization can include identification of one or more parameters that cause players to have a different experience and modification of one or more game features and/or game presentation to adjust, and/or normalize, a user gameplay experience in response to the parameters. Processes and device configurations may detect differences in gameplay from one or more game streams, user profile data, user hardware, and user environment data. According to embodiments, processes and device configurations are provided for network games, such as multiplayer or cloud based games. Embodiments determine and modify game output based on one or more performance factors for a user. Processes and device configurations may also be directed to virtual reality (VR) and augmented reality applications and systems.

According to embodiments, processes and device configurations are provided for normalization of gameplay experience. Embodiments are provided for normalization of the effects of one or more of network latency, device capability difference, device condition (e.g., oxidized contacts in a players controller) and player abilities (e.g., reaction time, precision with aiming, spatial awareness, etc.). Normalization may be performed for a player on a console game or a network game. Normalization may be performed for players playing with a console, and players in a multiplayer game session, wherein normalization may be based on player performance relative to one or more or players of a session. When multiple players engage in related gameplay there are many factors that can cause the players to have different gameplay experiences, such as network connections, player abilities or disabilities, or hardware differences. There are times when it is desirable to provide players with similar gameplay experience, such as when players play together in the same game match or tournament. It may also be desirable to provide players with similar game play experiences when they play the same game title on their own, such as to provide each player with a level of challenge that they find enjoyable. For example, it would be desirable to allow a player with slow reaction times to be able to get the same enjoyment from a game title, like a first-person shooter, that relies on player reaction times by modifying one or more game operations. If players competing against each other have a consistent gaming experience it may makes for more competitive gameplay where each player has a chance to win if they play to the best of their ability.

According to embodiments, processes and device configurations are provided for electronic gaming control and performance normalization. Processes and device configurations can include receiving a game data stream for an electronic game, wherein the game data stream includes game data for at least one user of the electronic game, and analyzing performance of the at least one user using the game data stream. A user performance rating may be determined for the at least one user, wherein the user performance rating is determined based on gameplay actions of the least one user. A normalization setting may be determined for the at least one user of the electronic game based on the user performance rating, the normalization setting modifying at least one game operation of the electronic game. The process may include controlling output of the game data stream using the normalization setting for the at least one user. Normalization methods may include detecting differences in gameplay experiences for players and methods for adjusting ways that players experience gameplay.

Processes and device configurations can include detection and processing of game data using one more models, such as a machine learning (ML) model, to identify and control normalization of one or more functions and objects of a game title including processing of reaction times, setting game target sizes, controlling game action responses, adjusting functions due to network lag, adjusting functions due to system configurations and adjusting game operations due to player ability. Embodiments are directed to training one or more machine models to identify one or more sources of lag, performance delay and user ability. Machine models may be configured to normalize one or more operations of a game and game system.

Embodiments are directed to systems, devices and methods for game operations and controls, including operations for gameplay normalization. Embodiments may be performed by gaming systems including one or more of consoles and network devices such as servers (e.g., cloud server, network server, back end server, etc.). Gaming systems may include consoles that play game media, consoles that provide network data for games, handheld devices, mobile devices (e.g., tablets, mobile phones, etc.) and devices in general configured for electronic gaming.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### EXEMPLARY EMBODIMENTS

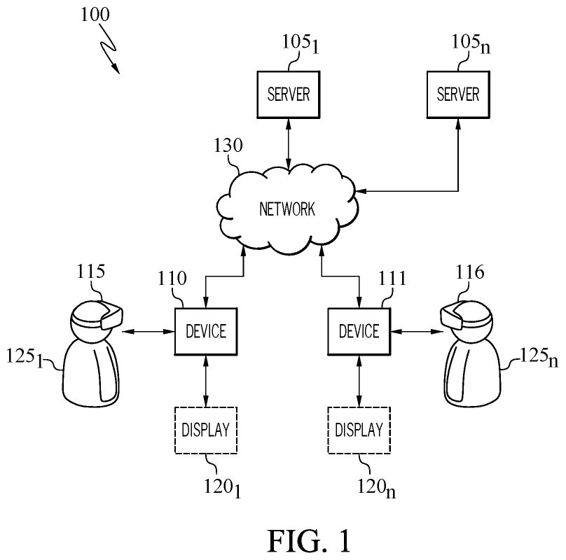

FIG. 1 is a graphical representation of electronic gaming control and performance normalization according to one or more embodiments. Electronic gaming control and performance normalization may be performed by one or more devices of system 100.

Operations of system 100 may be performed by one or more of servers 105₁₋ₙ and devices, such as device 110 and device 111, for controlling and/or normalization of game streams. Devices 110 and 111 may be a game console and/or an interactive device configured to output game content to a user, such as users 125₁₋ₙ. Devices 110 and 111, may be a game console, entertainment device, display device or media player. According to embodiments, system 100 may include one or more of servers 105₁₋ₙ to service one or more game devices. Servers 105₁₋ₙ may be one or more network devices. Servers 105₁₋ₙ may each be a network device configured to provide game data including game data streams for network or multiplayer games. According to embodiments, at least one of devices 110 and 111, and servers 105₁₋ₙ may be used to output an electronic game for one or more users, such as user 125₁₋ₙ. According to embodiments, system 100 may perform one or more operations on a game stream for electronic gaming control and performance normalization.

According to embodiments, processes and device configurations may be performed for a user, such as user 125₁, to play an electronic game provided by one or more of a device, such as device 110, and a server, such as one or more of servers 105₁₋ₙ. System 100 may allow for hosting one or more multiplayer game sessions for user 125₁ with one or more other user, such as user 125ₙ. Similar to user 125₁, user 125ₙ may receive game stream data for an electronic game provided by one or more of a device, such as device 111, and a server, such as one or more of servers 105₁₋ₙ. Users 125₁₋ₙ may view game stream content from one or more devices such as device 110, and 11, and/or one or more wearable devices, such as device 115 and 116. Users of system 100 may be presented game content on optional displays, such as displays 120₁₋ₙ. According to embodiments, processes and configurations may be configured to normalize the experience of one or more users, such as one more of users 125₁₋ₙ. Normalization may be based on one or more detected parameters including the type and condition of deices of system 100. Devices of system 100 may communicate with servers 105₁₋ₙ by way of network 130.

According to embodiments, users 125₁₋ₙ may utilize one or more devices to participate in a gameplay session. By way of example, user 125₁ may interact with and/or operate at least one of device 115, device 125₁ and display 120₁ to participate in a gameplay session. These devices may be configured for presenting game media, such as electronic game content, receiving user controls and providing user control and game data to one or more network devices, such as server 105₁, for one or more game functions. Server 105₁ may be configured to host and provide data for more game services. According to embodiments, a game stream may include data received by and/or provided to a device, including one or more of device 115, device 125₁ and display 120₁, from server 105₁. During operation of a game, a game data stream may be provided to one or more devices to allow for presentation of game content. System 100 may be configured to control presentation of content associated with an electronic game. System 100 may also be configured for identifying one or more parameters for normalizing game content.

Device 105 may be configured to control and present gaming content for one or more users, such as user 125₁. Device 110 may be a control device, such as a console, configured to operate with one or more peripherals or control devices, such as a game controller (e.g., handheld controller) and optional display 120₁. According to embodiments, user 125₁ may receive game stream data to wearable device 115 which may include a display, communication interface and a controller. Game stream data received by devices may include audio and video data for presentation of an electronic game. Device 115 may receive one or more of audio data, and visual (e.g., video) data for presentation of an electronic game. Device 110 may be configured to receive user controls by way of one or more controllers. According to embodiments, device 110 may output gaming content to display 120₁. Communication with server 105₁ may be by way of network 130 to provide one or more multiplayer game operations.

According to embodiments, system 100 is configured to allow for control and presentation of electronic gaming content, such as content associated with a multiplayer game. In addition, embodiments are directed to providing gaming content based on user performance. System 100 may also be configured to output gaming content by way of one or more game data streams. According to embodiments, the game data streams may be configured prior to transmission over network 130. According to other embodiments, game data streams generated by a server or hosting device may be modified to normalize gameplay experiences. It should be appreciated that operations and processes for collection of user data, including user profile and reaction timing, may be based on expressed consent of a user. Users may be notified of operations and collection of user data. Operations may also require adult confirmation and user agreement for operations to be performed on a console or a device. System 100 may provide features to improve user experience, wherein functions and operations described herein are performed following user consent, with express notice to a user, and/or in alignment with one or more user settings for user privacy. It should be appreciated that embodiments may be applied to interactive entertainment with one or more users. Processes described herein are not limited to gaming content.

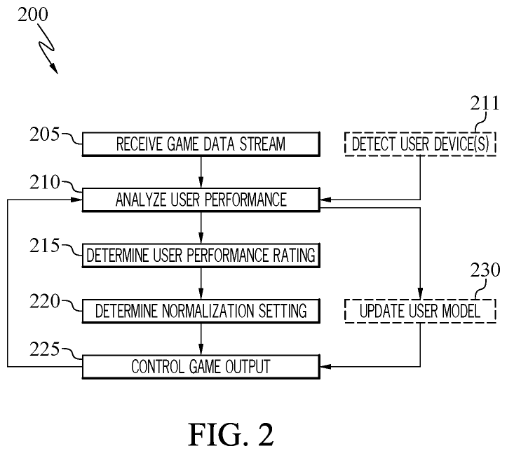

As discussed below in more detail with respect to FIGS. 2, 4 and 5, processes are provided for electronic gaming control and performance normalization relative for one or more users, such as users 125₁₋ₙ and users accessible by way of network 130. System 100 may operate for multiplayer games. According to embodiments, server 105₁ may be configured to provide game data streams to one or more users of a multiplayer game. Server 105₁ and one or more additional servers of system 100 (e.g., server 105ₙ), may be configured to manage a multiplayer gaming session for one or more devices, such as devices 110 and 111 and one or more wearable devices, such as devices 115 and 116, associated with users 125₁₋ₙ.

According to embodiments, servers 105₁₋ₙ may include a memory and/or database for storing one or more of game data, machine models, user profiles, and device characteristics (e.g., functions, limitations, etc.). Servers 105₁₋ₙ may also provide one or more multiplayer functions, such as providing a one or more game streams, player management and hosting of multiplayer games. Operations and game control signals generated by a user, such as users 125₁₋ₙ, may be detected by a controller/interface, received by device 105 and output to one or more devices of system 100 to provide normalization of one or more game functions.

According to embodiments, one or more devices of system 100, such as at least one of device 110 and servers 105₁₋ₙ may control an electronic game for a user and for determining one or more normalization settings for users of the electronic game. Control of the electronic game may be network based, such that one or more operations are directed by control commands of servers 105₁₋ₙ. Device 110 may be local to user 125₁ and may perform one or more operations for normalization and/or to implement control commands received from a server for one or more users. According to embodiments, devices local to a user, such as devices 110 and 111 may be configured to normalize one or more game functions. According to embodiments, one or more components of system 100, such as device 110 and server 105₁ may perform processes relative to one or more game streams. By way of example, device 110 may control presentation of an electronic game on display 120₁ for user 125₁ and device 110 may exchange data with server 105₁ over network 130. Server 105₁ may receive data from one or more other devices, such as devices 110 and 111 for users 125₁₋ₙ. According to embodiments, a game data stream generated for device 110 associated with user 125₁ may include game data for one or more game elements controlled by user 125₁ and one or more game elements associated with other users of the gameplay session, such as user 125ₙ. According to embodiments, system 100 may perform one or more processes for receiving a game data stream for an electronic game, analyzing performance of user and determining at least one normalization setting. System 100 may update the game data stream to include the at least one normalization setting and output the game stream. By way of example, detection of user 125₁ performing poorly in a game may result in system 100 controlling one or more game parameters to improve experience for user 125₁. Normalization may be based on one or more players of a game session. When performance of a user, such as user 125₁ exceeds performance of other players, one or more functions may be normalized for user 105₁. As discussed herein, normalization settings may modify one or more game functions and objects to adjust the experience for one or more players. According to embodiments, servers 105₁₋ₙ may be network servers, backend servers, game servers, and servers device in general configured to provide multiplayer game data. Servers 105₁₋ₙ may be configured to perform one or more operations with respect to user profiles for a user, such that normalization allow for players with different preferences and/or playing restrictions to modify game content according to player restrictions. According to other embodiments, normalization may adjust settings based on detected differences in player devices (e.g., hardware, control inputs, etc.).

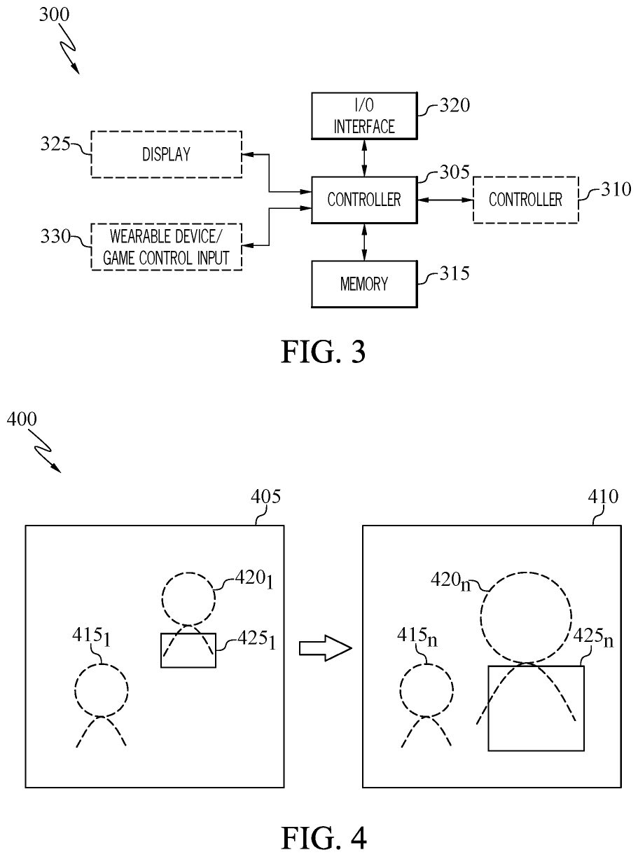

FIG. 2 illustrates a process for electronic gaming control and performance normalization according to one or more embodiments. Process 200 may determine one or more normalization settings for an electronic game. In addition, process 200 may track user performance and control one or more of game objects, game functions and game settings for one or more of entertainment, and to control a game play experience. Process 200 may be performed by a device, such as device 110 or server 105₁ of FIG. 1, controller 305 of FIG. 3, or a control device in general.

Process 200 may be initiated by a device receiving a game data stream at block 205. When performed by a network device, such as server 105₁, the game stream data may include gameplay data received from one or more user devices, such as game consoles or media players. The server device may be configured to process game streams from users to determine one or more game actions and data to broadcast to users of a multiplayer game. When performed by a control device local to, or associated with, a user, such as device 110 associated with user 125₁, the game data stream may include one or more components for presentation of a game. Control devices and consoles may include media or game data local to presentation of a game, the game media configured to receive one or more game data streams to allow for multiplayer gameplay. Process 200 is described below as being performed by a device. According to embodiments, process 200 may be performed by one or more of control devices, consoles and network devices such as servers of a system (e.g., system 100).

According to embodiments, process 200 may be performed as part of and/or in addition to one or more processes for providing a gameplay session for multiple players. Process 200 may receive game data streams including user operations and game responses for a plurality of users at block 205. Receiving game data streams can include receiving game data streams for the at least one first user and a game data stream for at least one second user. Normalization settings of process 200 may be determined based on a performance rating of the at least one user relative to a performance rating of the at least one second user. Game data streams can include one or more of graphics, code to direct graphics, user controls, network timing and code describing game functions to present a game. According to embodiments, a control device may receive a game stream for each user of an electronic game. Receiving a game stream may include receiving uplink signals from one or more user devices and detecting one or more downlink communications transmitted to one or more users.

At block 210, process 200 includes analyzing performance of the at least one user using the game data stream. According to embodiments, performance of a user may be used for normalization of one or more game functions. According to embodiments, user performance may be determined based on reaction time of a user. Reaction time for a user may be detected based on timing that commands are received by a device. Users of a game title may generate input commands for the game title with a range of reaction times. In some cases the user reaction time may be delayed due to user ability, while reaction may be due to one or more of devices/hardware used and network lag. Process 200 may include detecting player interactions including reaction time of user. The reaction time may be detected using player inputs and/or input controls compared to events in game stream. Timing and averages of other player commands may also be used to detect and assess reaction time for a user. Analyzing performance of the at least one user can include tracking user game stream data for the electronic game for a period of time and detecting at least one of user performance data for the game, network lag data and device lag data. According to embodiments, analyzing performance of the at least one user includes tracking user performance for the electronic game a for a period of time and determining a performance rating for the user for a period of time associated with a received game data stream.

According to embodiments, analysis of user performance includes use of a machine learning model (e.g., use artificial intelligence (AI) analysis) to detect player interactions with games to detect details of the player experience. The machine learning model may receive various information as input including as video and audio rendering that is presented to the player, inputs from a controller used by the player, a microphone capturing the player, a camera showing the player, eye tracking data of the player, a chat corresponding to the game play, biometric information from the player, network performance information, game state information from the game title, information from the game system software, and/or information corresponding to other players playing the game, Using receive inputs, user performance maybe tracked at block 210 including storing one or more of user scores, user rankings, user game progress and user game data in general to determine one or more points of reference for analyzing user performance in one or more electronic games. For multiplayer games, tracking user performance can include tracking user rank or standing for game sessions. Tracking user performance can include storing user data for one or more game titles.

Examples of user performance may include detecting user ability to perform game functions. Player interaction may be detected based on image data of a game session, and game data streams. Analyzing user performance may be based on one or more game title functions. For example, analyzing user performance may include measuring a player's ability to hit a target or avoid getting hit. Normalization settings may be determined to compensate for differences to give players a similar difficulty in hitting a target and avoiding getting hit, create a larger hit zone for an opponent, create a smaller hit zone for a player, and/or adjust speed of enemy swings or movement of other threats. By monitoring an expected result relative to a user controls, a machine learning model may user controls and game outputs as a training.

According to embodiments, process 200 optionally detects user devices at block 211. Detection of user devices may be performed to determine if a hardware or input devices impart an effect on user input controls. Hardware performance may degrade with use, due to age, or due to damage of parts. Detection of hardware devices may include identification of a particular hardware device based on communication or connection with the device, such as a wearable (e.g., device 115). Device detection may include determining one or more communication limitations of devices, such as hardware and/or software configurations, that limit the ability of a device to receive, detect and/or transmit electronic game data relative to a user. Device detection may be based on user profile information stored by devices in communication with one or more devices controlling presentation of gameplay content. Device detection may include detection of device capabilities based on user during one or more gameplay sessions.

At block 215, process 200 includes determining a user performance rating for the at least one user. User performance ratings may be determined based on gameplay actions of the least one user. User performance ratings may be determined to generate a metric and parameters for normalization of game functions. Some game operations may be easy for users of a gameplay session to perform, while other functions maybe difficult for users to perform. Similarly, it may be difficult to assess or identify how difficult a game operation is merely based on a game score. A user performance rating may be determined to score or rate a user, and/or user devices, with respect to an electronic game or game title. Similarly, a user performance rating may be used to score or rate a user relative to one or more other participants of a gameplay session. According to embodiments, determining a user performance rating can include storing one or more of user scores, user rankings, user game progress and user game data in general to determine one or more points of reference for analyzing user performance in one or more electronic games. For multiplayer games, tracking user performance can include tracking user rank or standing for game sessions. Tracking user performance can include storing user data for one or more game titles.

User performance ratings may be determined at block 215 based on data determined for a user, such as user performance analyzed at block 210 and one or more user scores or rankings for an electronic game. Game data such as a players current rank, score total, level, achievements, etc. can be used and determined from a game stream and/or game engine data to determine how a player is performing. Analysis may include a determination of a player performing well, poorly, or within a range of ratings, such as a rating system, from poor to well.

According to embodiments, determining a user performance rating at block 215 can include determining user performance ratings for one more users. For example, a user performance rating may be determined for at least one first user and one or more additional users. Performance ratings may be determined based on gameplay actions of the least one user relative to one or more users of a game session. By way of example, a first user may have a lower accuracy compared to a second user. By comparing users relative to other users of a gameplay session, processing and outcomes may be simplified for a gameplay session compared to determining a user performance rating applicable to all gaming situations. According to embodiments, devices and/or servers may determine performance ratings for at least one user using a machine model. The machine model may receive one or more game streams and/or user information to determine at least one normalization parameter for modification of a game function. According to embodiments, process 200 may use a machine model trained to identify at least one of user performance for the game, network lag and device lag for normalization.

At block 220, process 200 includes determining a normalization setting. According to embodiments, at least one normalization setting may be determined for the at least one user of the electronic game based on a user performance rating of process 200. The normalization setting may be used by a control device to modify at least one game operation of the electronic game. Determination of a normalization setting for the at least one user includes identifying at least one game feature for modification. According to embodiments, normalization settings are determined based a performance rating and at least one normalization parameter for the user.

According to embodiments, a normalization setting for the at least one user includes modification of at least one game feature to modify the constraints for completing the game function by the user. Modification of game features can include reducing difficulty, and/or increasing difficulty. For a first user a target zone for completing a task (e.g., inflicting damage, hitting a target, etc.) may be reduced as an example of increasing difficulty. Game functions may be modified to reduce difficulty by allowing a user more time to correct operation or control of movement of a game object in order to reduce constraints to complete a game function.

Process 200 may determine a normalization setting to normalized and/or compensate for at least one of network latency, device capability differences, device condition (e.g., oxidized contacts in the player's joystick, etc.) and player abilities (e.g., reaction time, precision with aiming, spatial awareness to tell what direction dangers come from, etc.). According to embodiments, a normalization setting for the at least one user includes modification of at least one game feature modify network lag for the at least one user. Network devices and control devices may not be able to change the throughput of a network, however, the data provided to users and timing of events of a multiplayer game session may be modified to limit the impacts of network lag on a user. Normalization based on network lag may include controlling game data stream output and/or controlling presentation devices to request uploads of data. At least one second user may be controlled to account for delay of the first user. By way of example, network speed may be synchronized to level out presentation time either by thread or by sending information to the one or more consoles like the second console to allow for presentation.

According to embodiments, a normalization setting for the at least one user includes modification of at least one game feature to reduce hardware lag of the at least one user.

According to embodiments, a normalization setting may include at least one parameter to adjust game settings based on user devices and user hardware. The normalization setting may shift one or more calculations from a server device to local hardware to compensate for network lag. By way of example, an enemy that a player is fighting against can be rendered locally with low latency and can be composited over the background. As such, a game object, the enemy, may be rendered remotely and streamed with the corresponding network lag. In such a case, the network lag on the background rendering may not have much effect on the user. In addition, the normalization setting may result in a user not experiencing network lag on rendering the fast-moving target they are focused on, which would have a significant negative impact on their game play experience. When two or more players have different devices, a normalization setting make a similar game experience for two players with different hardware, such as a player with a device with lots of computation power on a slow network connection that does some computation locally playing against a player on a device with limited computation power on a fast network connection that streams the final rendering.

According to embodiments, normalization settings may be determined to allow for different portions of game renderings that can be transmitted separately and composited together by a player's device. The different portions of the rendering can have different resolutions and/or frame rates. There can be more than one option for each portion of the rendering, such that when network bandwidth is low a player's device can switch to a lower frame rate for the background rendering to reduce bandwidth usage while continuing the stream the fast-moving opponent at full bandwidth to minimize the impact on the player's game play experience. A background can be a fairly static image that simply shifts position as the camera angle pans, which can make a rendering of the background very efficient if it does not contain the fast-moving foreground elements. Different streams may be transmitted with different priority so that the streams most important for game play experience are least likely to be delayed for other traffic.

According to embodiments, a normalization setting may include at least one parameter for adjusting the location of computing to compensate for game play experience differences. For example, a computation for generating game data streams can be moved to a server with more capability or less load so that the computation can be performed quicker. As another example, a computation for game data streams can be moved to a server in a data center that is closer to the player to reduce the network latency to transmit the final rendering to the player. In some cases, all processing for a game match can be transferred to a server to balance the network latency for all players in the game match, which might also take other factors effecting game play experience into account. In addition, more compression can be applied to some portions of the rendering than others, which can reduce the bandwidth required which will reduce the network latency to transmit the rendering.

According to embodiments, a normalization setting determined by process 200 may include at least one parameter for adjusting user ability. User performance may indicate that a player consistently misses a target, such as shooting a target or controlling an object. Process 200 may determine that the game function is missed due to network lag and/or a slow player reaction time. Regardless of the cause of the consistent misses, compensation can be used to improve the game play experience of the player. According to embodiments, a hit zone can be shifted or extended to include the area where the target was slightly earlier to give the player the experience of shooting where they think they think they should with the timing that seems correct to them will result in their shot hitting the target they were aiming for.

According to embodiments, a normalization setting may include at least one parameter for a introducing a random outcome normalization. A normalization setting may include use of a random number generator to determine when a player receives a more powerful object than other players in a multiplayer session. The random number generator may have a first opponent fighting a first player get lucky with their swings while a second opponent fighting a second player may keep missing their swings. Adjusting probabilities for random number generation or forcing the outcome of a random choice can be done to compensate for player game experience differences.

According to embodiments, a normalization setting may include at least one parameter for a hardware differences, such as PC vs console vs VR headset vs mobile. These devices may have display configurations of 720p, 1080p or 4K HDR with differences in audio sampling rate, frequency response, or 3D audio rendering ability. Game elements may be adjusted to allow for users with lower resolution displays to view game objects.

According to embodiments, a normalization setting may include at least one parameter for controlling in game features, such as modifying non-player character (NPC) behavior customized to enhance the player experience. Customizations to game functions may be retuned or made as the player progresses or other factors change.

According to embodiments, a normalization setting may include at least one parameter for a machine model to reduce details that are included in a rendering to reduce rendering time and/or bandwidth used. By way of example, a game data stream may be modified using a normalization setting to use a less bandwidth intensive texture for elements. By way of example, a rock wall that is not the focus of a player's attention may be presented with reduced bandwidth. Process 200 may use machine models to monitor the resulting game play to determine the extent the reductions have an effect on the player's game play experience and adjust the reductions it makes based on the determination.

According to embodiments, a normalization setting may include at least one parameter for a detection of a player using a bot by detecting consistent behavior and reaction time. The normalization setting may remove a player from a game or handicap the player by making it more difficult for that player so that their play level using the bot is balanced with the play of other players not using a bot. According to embodiments, a normalization setting may include at least one parameter to rebalance game play when one player drops out of a game match. If other players were limited to make their game play experience consistent with the player that left then those limits can be lessened to the new lowest common denominator. Similarly, a player may join a game match that is already in progress, which can trigger the limits to be rebalanced to the new lowest common denominator. Other factors can trigger a rebalancing, such as if one player starts experiencing network latency. Process 200 may determine other software running on a local device is interfering with a player's gaming experience. In some cases, the user may be provided with information to allow the user to terminate unneeded software on the local device that is interfering. In some cases, such as playing on a game console, the local rendering software may be given commands that terminate or throttle software that is interfering with game play.

According to embodiments, a normalization setting may include detecting one or more player preferences about what game experience normalization they prefer or enable for their game play. A player profile may be used to balance game experience normalization, such as to take into account if a player has a hearing or vision impairment. A normalization setting may control audio for players to be modified based on rendering capability of the players in a game. This modification can provide the players in the game a more uniform game experience as they all receive audio with similar characteristics. In some cases, the modifications may modify the frequency ranges in which sounds are rendered or reduce information rendered in particular frequency ranges. This may include reducing or eliminating sounds that compete with important game sounds, such as to turn down ambient sounds or music so that conversations and monsters are heard better. In some cases, one or more players will have a physical limitation that reduces their perception capacity, such as a loss of hearing in a particular range. The system may adjust the game experience to remove the audio information presented in that range for all players instead of just the one player with the hearing impairment to give all players in a game session a similar game experience.

At block 225, process 200 includes controlling game output. Output of game data streams may be controlled using one or more normalization settings for the at least one user. Control of game output at block 225 can be controlled to normalize at least one of network latency, device capability differences, device condition (e.g., oxidized contacts in the player's joystick, etc.,), player abilities (e.g., reaction time, precision with aiming, spatial awareness to tell what direction dangers come from, etc.) and normalization parameters in general. Based on game output, process 200 may analyze user performance at block 210 to determine any effects of a normalization setting for a gameplay session and determine a user normalization setting at block 215. If the normalization setting improves a user experience by normalizing a gameplay session for one or more users, the normalization setting may continue to be used for control of game output at block 225. When a normalization setting does not improve a gameplay experience, a new and/or modified normalization setting may be determined at block 220.

At block 230, process 200 may optionally update a user model. Users may each be characterized by one or more of user ability, a network a user is using and user devices. At optional block 230, process 200 may update at least one of a user profile and parameters of a machine learning model for determining user normalization settings based on user performance analyzed at block 210. Process may update a machine model for normalization based on the analysis of user performance for controlled output with at least one determined normalization setting. By way of example, when adjusting timing of game functions and/or events based on network speeds, the machine model can determine one or more settings for timing that work well for a user. Similarly, when modifying game functions, such as a game target zone, the model may identify parameters of the game modification that allow for improved performance of a user.

According to embodiments, process 200 and detection and use of normalization settings as described herein allow for normalization across a plurality of dimensions and based on other players in a game session. By way of example, conventional game settings that allow a user select a character that is not effected by game objects and thus remove the game function, process 200 allows for game functions to be modified to allow game functions to persist in a modified manner. Normalization may be performed for a period of time. Unlike game features being suspended but displayed, like a game enemy that cannot hurt a game character, features may be normalized that can be accounted to network delay. In addition, simply removing threats from a game may make the game unplayable. Process 200 and embodiments allow for leveling one or more game features to control game experience. In addition, features that effect game outcomes may be learned for each player in different situations.

FIG. 3 illustrates a graphical representation of a device configuration according to one or more embodiments. Device 300 is configured for detecting user performance for an electronic game and performance normalization. Device 300 represents one or more components and functions of server 105₁ and/or device 110. Device 300 may represent one or more of a gaming console, computing device, and electronic device in general configured to output one or more of video, audio and game data to an output device. Device 300 may provide one or more components of a server or network device.

Device 300 may be a control device or game console device which can include controller 305, memory 315 and input/output (I/O) interface 320. Device 300 may also optionally include game content 310. Device 300 may optionally include and/or communicate with at least one of optional display 325 and optional wearable device/game control input 330. Controller 305 may relate to a processor or control device configured to execute one or more operations stored in memory 315, such as processes for detecting gameplay actions of one or more users. Memory 315 may be non-transitory memory configured to provide data storage and working memory operations for device 300. Memory 315 may be configured to store computer readable instructions for execution by controller 305 for one or more processes described herein.

Device 300 may be configured to receive gaming media (e.g., card, cartridge, disk, download, etc.) and output visual and audio content of the gaming media to an output device, such as a display. Device 300 may be configured to provide a voice communication features for users of a game, such as a game chat. Control device 305 may be configured to receive game data streams by way of I/O interface 320. Controller 305 may also be configured for tracking user performance and normalization of one or more features of the game data stream. Controller 305 may be configured to store a user profile and/or update a user profile stored on a network.

Controller 305 may be configured to receive data from one or more other devices such as other console devices and servers (e.g., server 105ₙ) to present and output game content. For network games, controller 305 may receive game data from a network source, such as a server, by way of a network and may be configured to control audio features, including sound cues. Controller 305 may be configured to receive input from one or more peripheral devices. According to embodiments, controller 305 may be a controller for an immersive system, such as at least one of an augmented reality and virtual reality system. As such, controller 305 may be configured to control content for display, detect user reactions and control modification of one or more content streams. Optional display 325 may be a display configured to present electronic content, such as display content based on a game data stream. Optional wearable device/game control input 330 maybe one or more of a head mounted unit and wearable device configured to detect user input controls. Performance for a user may be based on reaction of a user to game content presented to the user by optional display 325 and optional wearable device/game control input 330.

FIG. 4 illustrates a graphical representation of normalization according to one or more embodiments. According to embodiments, control of a gameplay session and/or electronic game can include providing graphical and/or audio content to a user from one or more sources including game media, a user control device (e.g., gaming console, media player, etc.) and a network device. According to embodiments, process 400 may control presentation of an electronic game content 405 based on one or more received game data streams. FIG. 4 illustrates normalization according to one or more embodiments. Based on a received game stream, output of game content 405 can include game video objects such as player controlled object 415, and game object 4201. Game object 4201 may be a resource, other character, or other player controlled character including target zone 425₁. According to embodiments, based on user performance monitored by a device, at least one normalization setting may be determined for the user. By way of example, normalization may include modifying one or more of game play functions and gameplay operations. Process 400 may include modifying game content 405 to game content 410. Game content 410 may be presented based on a normalization to include player controlled object 415 and game object 4201 modified to game object 420ₙ. Game object 420ₙ may be presented with increased size based on a detection of a device configuration. For example, a user may be participating in a game session with poor or improper display configurations and game object 420, may be presented with larger size to normalize the gameplay experience for a user. According to embodiments, game content 410 may be presented based on a normalization to include player controlled object 415 and target zone 425₁ modified to target zone 425ₙ. Target zone 425, may be presented with modified (e.g., increased) size based on a detection of a device configuration. For example, a user may be bad at hitting a target or a controlling a character with respect to target zone 425₁. Normalization may include modifying target zone 425₁ to target zone 425, to provide a user with improved chance of completing a game function. It should be appreciated that normalization according to embodiments is not limited to increasing display size or modifying a target zone for a game function.

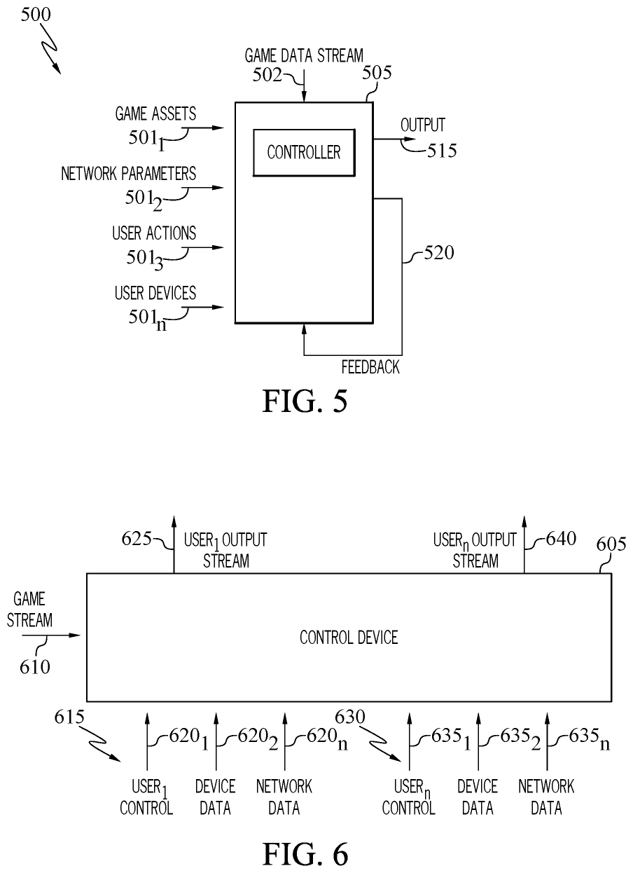

FIG. 5 illustrates a graphical representation of user performance training according to one or more embodiments. Process 500 may be performed to determine one or more normalization settings for an electronic game. Once a normalization setting is determined, game functions and features may be modified for one or more users of a gameplay session.

FIG. 5 illustrates training process 500 which can include receiving training parameters 501₁₋ₙ as training input by a device 505 including a controller 510. According to embodiments, controller 510 may receive a plurality of forms of gameplay data samples as training input. In embodiments, training parameters 501₁₋ₙ may include game assets 501₁, network parameters 501₂, user actions 501₃, and user devices 501ₙ. Based on training in process 500, controller 510 may generate output 515. Output 515 may include one or more game control parameters for control and/or presentation of game content. According to embodiments, controller 510 may be configured to generate output 515 based on a recursive loop including training and feedback. Feedback loop 520 may provide information such as ratings and accuracy for output 515.

According to embodiments, training process 500 and controller 510 may be configured to use one or more learning models (e.g., artificial intelligence, iterative models, etc.) to game audio. Training process 500 and controller 510 may use one or more libraries of user actions, and device configurations. According to embodiments, output 515 may include output of game content modified based on one or more user ability, network lag and device lag.

Training process 500 may be used to identify user ability based on player performance for cloud based gaming. Process 500 may also be used for detecting the effect of network lag on user gameplay. Process 500 may also determine whether device condition negatively impacts user performance.

According to embodiments, training process 500 performs game experience training to identify one or more parameters of a game title for modification. Training process 500 may generate a machine model configured to analyze user performance, determine a user performance rating and to determine a normalization setting. Based on one or more of game assets 501₁, network parameters 501₂, user actions 501₃, and user devices 501ₙ, user operations and control may be analyzed to detect a user performance rating as a function of a user's ability to complete a game action. In addition to user ability, the machine model may determine one or more operations for control of game data streams for at least one of adjusting game output for network lag, adjusting gameplay for hardware lag and hardware capabilities.

FIG. 6 illustrates a graphical representation of performance normalization according to one or more embodiments. According to embodiments, control device 605 may be configured to receive a game data stream 610 for an electronic game and to generate at least one user output game stream. Game data stream 610 may include one or more network streams of game data including control instructions for presentation of game content. In some embodiments, game data stream 605 may include content for presentation of a game. According to other embodiments, game data streams may include one or more data segments including control parameters that may be used by a device, such as a console or wearable device to present game content. According to embodiments, control device 605 may be configured to receive input parameters for a plurality of users which may be used to normalize game data stream 605.

Performance normalization in FIG. 6 illustrates inputs 615 for at least a first user and inputs 630 for at least one second user. During a gameplay session a first user and a second user may have different experiences including quality of a game and experience with game controllability. Inputs 615 for at least a first user include user control data 6201, device data 6202 and network data 620ₙ. Control device 605 may output stream 625 for a first user (e.g., User₁). Inputs 630 for at least a second user include user control data 6351, device data 6352 and network data 635ₙ. Control device 605 may output stream 640 for a second user (e.g., User₂). Normalizing game data streams to account for all player differences in a single stream may be difficult. However, certain modifications may be made to one or more players game data streams or data that is provided to the users. Normalization can include modification of game functions to modify one or more features for each user output stream including output stream 625 and output stream 640.

Control device 605 may be a controller for a network device providing game stream data for one or more users including output stream 625 and output stream 640 which may include content for augmented reality and virtual reality applications. Users

While this disclosure has been particularly shown and described with references to exemplary embodiments thereof, it will be understood by those skilled in the art that various changes in form and details may be made therein without departing from the scope of the claimed embodiments.

What is claimed is:

1. A method for electronic gaming control and performance normalization, the method comprising:
receiving, by a device, a game data stream for an electronic game, wherein the game data stream includes game data for at least one user of the electronic game;
analyzing, by the device, performance of the at least one user using the game data stream;
determining, by the device, a user performance rating for the at least one user, wherein the user performance rating is determined based on gameplay actions of the least one user;
determining, by the device, a normalization setting for the at least one user of the electronic game based on the user performance rating, the normalization setting modifying at least one game operation of the electronic game; and
controlling, by the device, output of the game data stream using the normalization setting for the at least one user.

2. The method of claim 1, wherein receiving the game data stream includes receiving the game data stream for the at least one user, receiving a game data stream for at least one second user, and where the normalization setting is determined based on performance rating of the at least one user relative to a performance rating of the at least one second user.

3. The method of claim 1, wherein analyzing performance of the at least one user includes tracking user game stream data for the electronic game for a period of time and detecting at least one of user performance data for the game, network lag data and device lag data.

4. The method of claim 1, wherein determining a performance rating for the at least one user includes using a machine model to determine at least one normalization parameter for modification of a game function, the machine model trained to identify at least one of user performance for the game, network lag and device lag for normalization.

5. The method of claim 1, wherein determining a performance rating for the at least one user includes determining at least one reaction time measurement for the at least one user relative to electronic game.

6. The method of claim 1, wherein determination of a normalization setting for the at least one user includes identifying at least one game feature for modification, and wherein the normalization setting is determined based a performance rating and at least one normalization parameter for the user.

7. The method of claim 1, wherein the normalization setting for the at least one user includes modification of at least one game feature to reduce the constraints for completing the game function by the user.

8. The method of claim 1, wherein the normalization setting for the at least one user includes modification of at least one game feature to reduce network lag for the at least one user.

9. The method of claim 1, wherein the normalization setting for the at least one user includes modification of at least one game feature to reduce hardware lag of the at least one user.

10. The method of claim 1, further comprising updating a machine model for normalization based on the analysis of user performance for controlled output with at least one normalization setting.

11. A device configured for electronic gaming control and performance normalization, the device comprising:
an interface;
a memory storing executable instructions; and
a controller coupled to the interface and the memory, wherein the controller is configured to
receive a game data stream for an electronic game, wherein the game data stream includes game data for at least one user of the electronic game;
analyze performance of the at least one user using the game data stream;
determine a user performance rating for the at least one user, wherein the user performance rating is determined based on gameplay actions of the least one user;
determine a normalization setting for the at least one user of the electronic game based on the user performance rating, the normalization setting modifying at least one game operation of the electronic game; and
control output of the game data stream using the normalization setting for the at least one user.

12. The device of claim 11, wherein receiving the game data stream includes receiving the game data stream for the at least one user, receiving a game data stream for at least one second user, and where the normalization setting is determined based on performance rating of the at least one user relative to a performance rating of the at least one second user.

13. The device of claim 11, wherein analyzing performance of the at least one user includes tracking user game stream data for the electronic game for a period of time and detecting at least one of user performance data for the game, network lag data and device lag data.

14. The device of claim 11, wherein determining a performance rating for the at least one user includes using a machine model to determine at least one normalization parameter for modification of a game function, the machine model trained to identify at least one of user performance for the game, network lag and device lag for normalization.

15. The device of claim 11, wherein determining a performance rating for the at least one user includes determining at least one reaction time measurement for the at least one user relative to electronic game.

16. The device of claim 11, wherein determination of a normalization setting for the at least one user includes identifying at least one game feature for modification, and wherein the normalization setting is determined based a performance rating and at least one normalization parameter for the user.

17. The device of claim 11, wherein the normalization setting for the at least one user includes modification of at least one game feature to reduce the constraints for completing the game function by the user.

18. The device of claim 11, wherein the normalization setting for the at least one user includes modification of at least one game feature to reduce network lag for the at least one user.

19. The device of claim 11, wherein the normalization setting for the at least one user includes modification of at least one game feature to reduce hardware lag of the at least one user.

20. The device of claim 11, further comprising updating a machine model for normalization based on the analysis of user performance for controlled output with at least one normalization setting.
